(19) United States
(12) Patent Application Publication
(10) Pub. No.: US 2005/0145238 A1
(43) Pub. Date: Jul. 7, 2005

(54) Laser diamond blocking machine for faceting the bottom of a diamond

(76) Inventor: Arvindbhai Lavjibhai Patel, Gujarat (IN)

Correspondence Address: CARSTENS YEE & CAHOON, LLP, P O BOX 802334, DALLAS, TX, 75380, US

(21) Appl. No.: 10/505,494

(22) PCT Filed: Feb. 6, 2003
(86) PCT No.: PCT/IN03/00020

(30) Foreign Application Priority Data
Apr. 3, 2002 (IN) 315/MUM/2002

(51) Int. Cl. B28D 5/00

(52) U.S. Cl. 125/30.01

(57) ABSTRACT

A laser diamond blocking machine is used to facet the bottom of the diamond. Mechanically this machine consists of four units, namely sliding unit, lifting unit, revolving unit, indexing unit. Sliding unit is for horizontal movement of 22 to 26 mm of die. The lifting unit is for the horizontal movement of die upto 15 mm. Indexing unit changes facet automatically as per number of facet selected through control panel. Motor changes the facet. For on-line faceting LEDs are there in the machine, one LED for each facet. This is time-saving mass processing.

### TECHNICAL FIELD

The present invention relates to LASER DIAMOND BLOCKING MACHINE FOR FACETING THE BOTTOM OF A DIAMOND. With the top of the diamond, bottom of the diamond is equally important to give shape to the diamond. Blocking is a process to facet the bottom of the diamond. According to the state of art faceting of the diamond is done manually with the help of diamond.

### BACKGROUND ART

The present blocking machine is used to facet the bottom of the diamond with help of laser. Mechanically this machine consists of four units.
a. Sliding unit
b. Lifting unit
c. Revolving unit
d. Indexing unit

Parts repeatedly used in all four machines are:
1. Base plate: to mount a motor or other components
2. Clamp: to support the shaft
3. Shaft: for relative movement
4. Ball bush housing: for friction free movement
5. Pin & Stud: for fitting purpose
6. Lever: to joint two units
7. Spacer: kept between bearings
8. Back Patti: to restrict the movement limit
9. Spring: for compressive fitting of parts
10. Ball bush & Ball Bearings: for horizontal or vertical or rotary movement
11. Self align bearing: to control the movement diversion, if any
12. Circlip support bearing
13. Check nut & Lock nut: for prevention of components from falling down

### DISCLOSURE OF THE INVENTION

The present invention will be described with greater specific and clarity with reference following drawings:

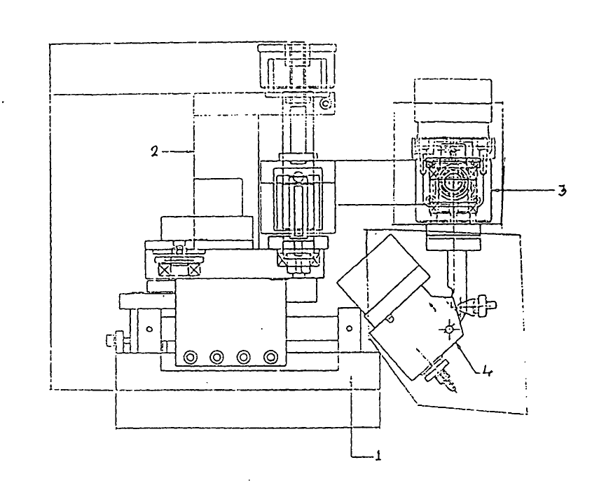

FIG. 1. represents the front view of the machine

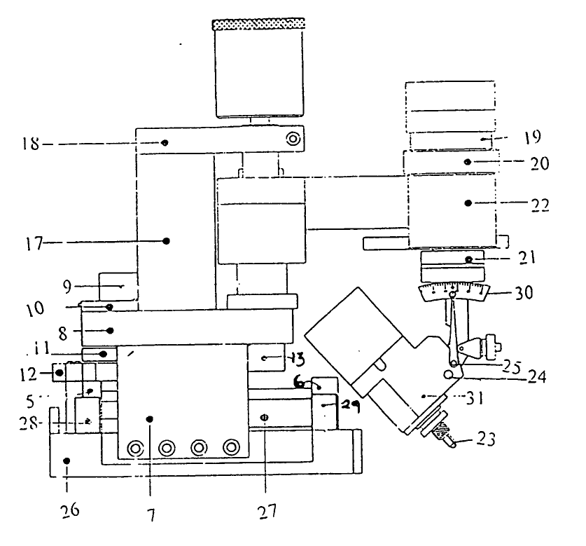

FIG. 2. represents the lay out of the machine showing parts of the machine

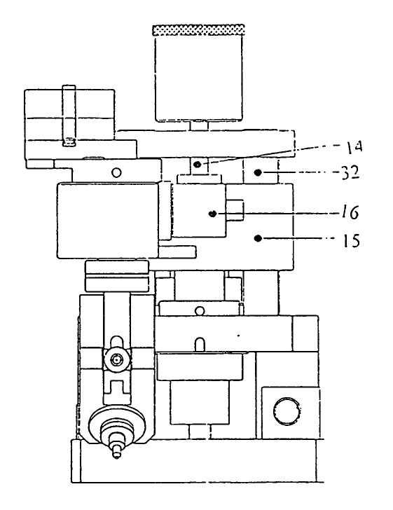

FIG. 3. the lay out of the machine showing parts of

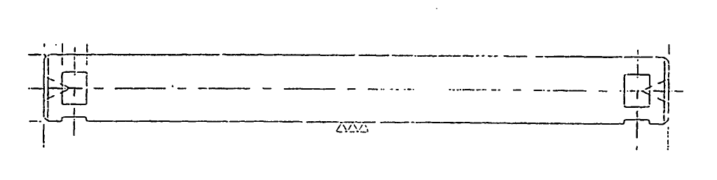

FIG. 4 represents the shaft

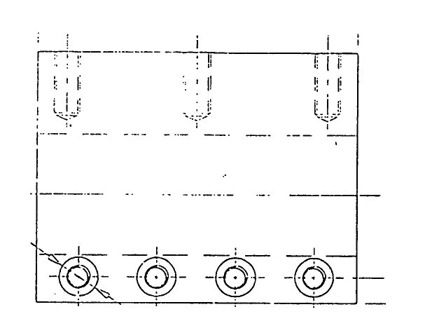

FIG. 5. represents the ball bush housing

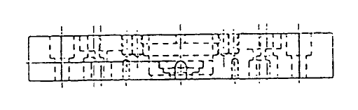

FIG. 6. represents the sliding plate

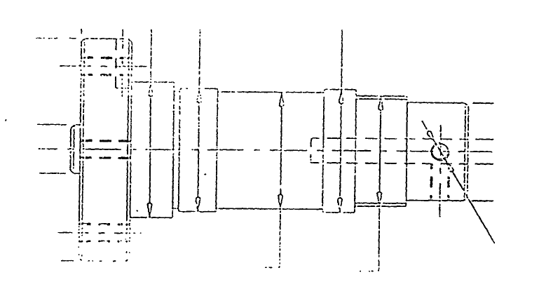

FIG. 7. represents the motor shaft

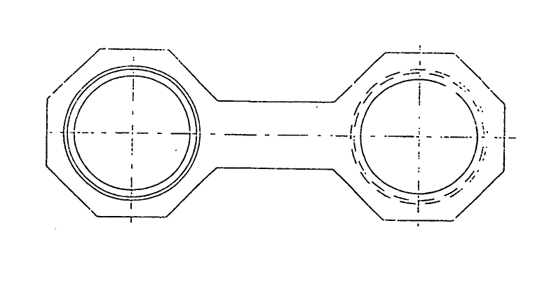

FIG. 8. represents the lever

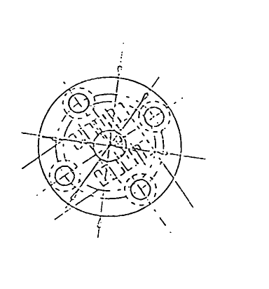

FIG. 9. represents the ball bearing

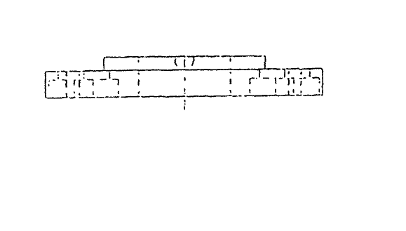

FIG. 10. represents the motor plate

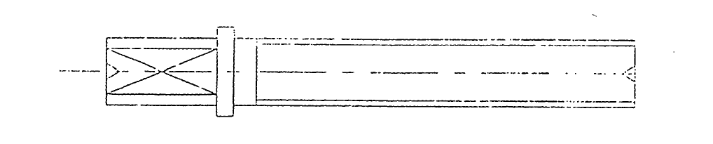

FIG. 11. represents the threaded stud

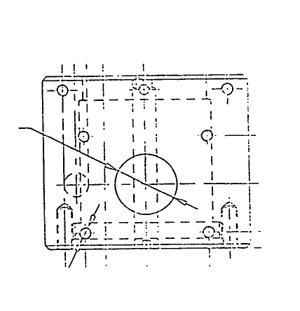

FIG. 12 represents the bearing holder

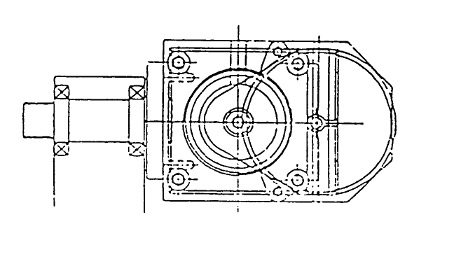

FIG. 13. represents the motor

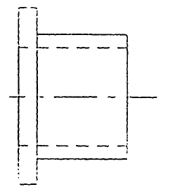

FIG. 14. represents the brass rivet

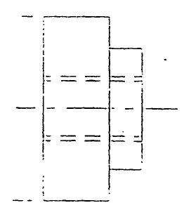

FIG. 15. represents the brass bush

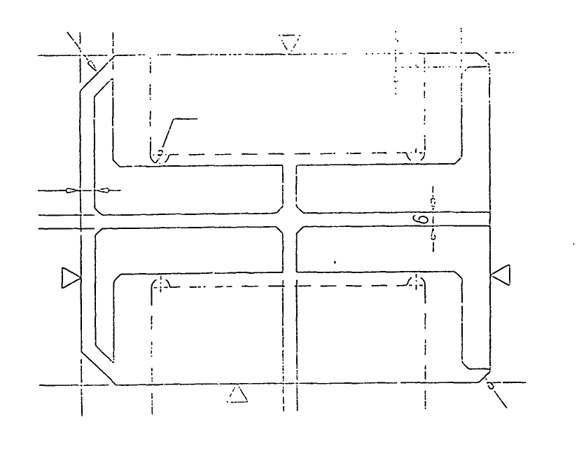

FIG. 16. represents the base plate

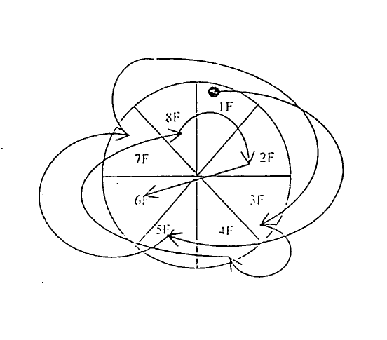

FIG. 17. represents the direction of the rotation of the facet.

Sliding unit 1 as a whole is mounted on base plate 26. On base plate 26, two shafts 27 by two ball bearings 28 & 29 are fitted. Two shafts 27 guide entire sliding unit 1. On each shaft 27 slider bush 5 & 6 is placed for friction-free movement. Ball bush housing 7 smoothens the movement of the slider 8. A motor 9 is mounted on a motor mounting plate 10. Motor shaft 11 is attached to slider 8. Self aligned bearing is placed into the lever 12.

In Lifting unit 2 lifting motor 13 is fitted below the motor mounting plate 10 of the sliding unit 1. Shaft 32 is fixed to motor mounting plate 10 by a screw, slit and deep groove bearing. Ball bush housing 7 is protected by steel cover. At the bottom of steel cover, thrust bearing is placed with its holder where motor shaft is fitted. Inside the thrust bearing holder there is thread screw for lifting action. Threaded stud 14 has threads along its ID and ball bush housing 15 is kept for smooth movement of stud 14. Inside the stud 14, steel ball is placed for the bottom limit. Ball bush housing 15 is attached with lever 16 at 90 degree. Lever 16 is an interface for ball bush housing 15 and revolving unit 3. Spring is placed to fit diamond. Spacer 17 supports both, motor mounting plate 10 and top plate 18.

In Revolving unit 3 also there is a motor 19 for the rotation of the unit. Motor 19 is fitted on the base plate 20. Motor shaft 21 is locked by a grub screw. In the bearing holder 22 two bearings are there. Two friction spacers are there, one for inner and one for outer race of bearing. Check nut holds the bearing—1 nut each for both the bearings. Check nut and lock nut hold the shaft and prevent from falling down.

Collate 31 is mounted on indexing unit 4 that holds the die 23. Polishing angle scale contains brass knob assembly with stud, bush 24 & rivet 25. Polishing angles set by brass knob and spring is to maintain the set angle.

Weight control unit compensates the natural weight of machine that directly acts upon diamond during polishing. This unit is placed on lifting unit 1. In this machine weight control knob, weight control spring and weight scale 30 are there to see the weight of the machine, acts upon diamond.

In Electronic assembly there is a common power supply for all four units. power supply provides electricity to control panel & sensors. It has battery back-up so that whenever power fails, it gives power failure signal to the control panel. Control panel consists a driver for all the units' motor. It generates command signal for LCD & LED to display the status of diamond regularly. Keypad is attached with control panel. For the control panel, a program is also designed.

The present invention of blocking machine is to facet the bottom of the diamond. Sliding unit is for horizontal movement of 22 to 26 mm of die. The lifting unit is for the horizontal movement of die upto 15 mm. Indexing unit changes facet automatically as per number of facet selected through control panel. Motor changes the facet.

In the sliding unit cam mechanism with two bearings converts the rotating motion into linear motion. The lifting unit lifts up and down the unit when it is needed to change the polishing direction or facet to remove unwanted scratch on the diamond. To find out grain structure of the diamond, revolving unit changes the polishing direction. System tries to polish diamond in one direction if grain matches. If grain structure does not matches, it changes polishing direction through revolving unit. Indexing unit changes the facet automatically as per the number of facet selected through control panel.

LCD (liquid crystal unit) displays the status of diamond, set parameters, function and selection parameter of system, also display message if it found any faulty direction in system. LCD also works as a bridge between operator and system and LED (light emitting diode) shows currently which facet is polishing, which facet have been polished and status of remaining facet. After completion of diamond polish the LED on control panel as well as on the top of the unit indicates that the diamond is over.

When die is fitted on blocking machine, control unit is used to decide the point of start. For this operator has to set the parameters according to the requirement of the program of the control panel. These parameters are set through keypad and LCD. For on-line faceting LEDs are there in the machine—one LED for each facet. First, first facet starts and then machine can change “Chall” itself for the perfect faceting. After faceting the first facet, fifth facet comes, then seventh and third facet will come. Thus odd facets are chosen first and then even facets will be chosen. This is shown very well in the FIG. 2. “Chall” time can be set from 1 second to 60 seconds. This time setting depends on the type and size of diamond

1. LASER DIAMOND BLOCKING MACHINE FOR FACETING THE BOTTOM OF A DIAMOND comprising of Sliding unit, Lifting unit, Revolving unit and Indexing unit.

2. LASER DIAMOND BLOCKING MACHINE FOR FACETING THE BOTTOM OF A DIAMOND as claimed in claim 1 four units comprising base plate, Clamp, Shaft, Ball bush Bearings, Self align bearing, Circlip support bearing and Check nut & Lock nut.

3. LASER DIAMOND BLOCKING MACHINE FOR FACETING THE BOTTOM OF A DIAMOND as claimed in claim 1 and 2 base plate is used to mount a motor or other components.

4. LASER DIAMOND BLOCKING MACHINE FOR FACETING THE BOTTOM OF A DIAMOND as claimed in claim 1 and 2 clamp is used to support the shaft.

5. LASER DIAMOND BLOCKING MACHINE FOR FACETING THE BOTTOM OF A DIAMOND as claimed in claim 1 and 2 shaft is used for relative movement.

6. LASER DIAMOND BLOCKING MACHINE FOR FACETING THE BOTTOM OF A DIAMOND as claimed in claim 1 and 2 ball bush housing is placed for friction free movement.

7. LASER DIAMOND BLOCKING MACHINE FOR FACETING THE BOTTOM OF A DIAMOND as claimed in claim 1 and 2 pin & stud are used for fitting purpose.

8. LASER DIAMOND BLOCKING MACHINE FOR FACETING THE BOTTOM OF A DIAMOND as claimed in claim 1 and 2 lever is to joint two units.

9. LASER DIAMOND BLOCKING MACHINE FOR FACETING THE BOTTOM OF A DIAMOND as claimed in claim 1 and 2 spacer is kept between bearings.

10. LASER DIAMOND BLOCKING MACHINE FOR FACETING THE BOTTOM OF A DIAMOND as claimed in claim 1 and 2 back patti is to restrict the movement limit.

11. LASER DIAMOND BLOCKING MACHINE FOR FACETING THE BOTTOM OF A DIAMOND as claimed in claim 1 and 2 spring is for compressive fitting of parts.

12. LASER DIAMOND BLOCKING MACHINE FOR FACETING THE BOTTOM OF A DIAMOND as claimed in claim 1 and 2 ball bush & ball bearings are for horizontal or vertical or rotary movement.

13. LASER DIAMOND BLOCKING MACHINE FOR FACETING THE BOTTOM OF A DIAMOND as claimed in claim 1 and 2 self align bearing is to control the movement diversion, if any.

14. LASER DIAMOND BLOCKING MACHINE FOR FACETING THE BOTTOM OF A DIAMOND as claimed in claim 1 and 2 check nut & lock nut are for prevention of components from falling.

15. LASER DIAMOND BLOCKING MACHINE FOR FACETING THE BOTTOM OF A DIAMOND as claimed in claim 1 for on-line faceting LEDs are there in the machine.

16. LASER DIAMOND BLOCKING MACHINE FOR FACETING THE BOTTOM OF A DIAMOND as claimed in claim 1 LCD (liquid crystal unit) displays the status of diamond, set parameters, function and selection parameter of system, and display message.

17. LASER DIAMOND BLOCKING MACHINE FOR FACETING THE BOTTOM OF A DIAMOND as claimed in claim 1 sliding unit is for horizontal movement of die upto 22 to 26 mm.

18. A NOVEL LASER DIAMOND BLOCKING MACHINE FOR FACETING THE BOTTOM OF THE DIAMOND as claimed in claim 1 the lifting unit is for the horizontal movement of die upto 15 mm.

19. A NOVEL LASER DIAMOND BLOCKING MACHINE FOR FACETING THE BOTTOM OF THE DIAMOND as claimed in claim 1 indexing unit changes facet automatically as per number of facet selected through control panel.

20. A NOVEL LASER DIAMOND BLOCKING MACHINE FOR FACETING THE BOTTOM OF THE DIAMOND as claimed in claim 1 and 20 motor changes the facet.

21. A NOVEL LASER DIAMOND BLOCKING MACHINE FOR FACETING THE BOTTOM OF THE DIAMOND as claimed in claim 1 and 18 in the sliding unit cam mechanism with two bearings converts the rotating motion into linear motion.

22. A NOVEL LASER DIAMOND BLOCKING MACHINE FOR FACETING THE BOTTOM OF THE DIAMOND substantially herein described with reference to the foregoing description and the accompanying drawings.
